(19) United States
(12) Patent Application Publication
(10) Pub. No.: US 2026/0251390 A1
(43) Pub. Date: Aug. 27, 2026

(54) METHOD AND PLANT FOR SEPARATION OF CARBON DIOXIDE (CO2)

(71) Applicant: AKER CARBON CAPTURE NORWAY AS, Lysaker (NO)

(72) Inventors: Kjetil BERGET, Oslo (NO); Simon SIMPSON, Valby (DK); Mette STENSENG, Kongens Lyngby (DK); David BERSTAD, Trondheim (NO); Julian STRAUS, Trondheim (NO)

(21) Appl. No.: 18/875,042

(22) PCT Filed: Jun. 13, 2023
(86) PCT No.: PCT/EP2023/065703

§ 371 Date: Dec. 13, 2024

(30) Foreign Application Priority Data
Jun. 16, 2022 (NO) 20220684

(51) Int. Cl. F25J 3/06; B01D 53/047; F25J 3/08

(52) U.S. Cl. CPC F25J 3/067; F25J 3/08; B01D 53/047; B01D 2256/16; B01D 2257/504; F25J 2205/10; F25J 2215/80; F25J 2220/82

(57) ABSTRACT

In some implementations, a process for separation of carbon dioxide from more volatile components in a gas mixture comprises: providing a bulk flow of the gas mixture; compressing the bulk flow in a compressor arrangement; cooling the compressed bulk flow in a heat exchanger arrangement; separating the cooled and compressed bulk flow in a bulk vapour-liquid separator; heating the cold bulk liquid in the heat exchanger arrangement so as to form a heated bulk liquid; expanding and separating the heated bulk liquid in a flash separation arrangement; recirculating the one or more outgoing gas flows from the one or more flash separation units to the compressor arrangement; providing a CO₂ product flow from the outgoing liquid flow from the flash separation arrangement, and providing a CO₂-depleted outgoing flow from the flow of cold bulk gas.

### TECHNICAL FIELD

This disclosure relates to a method and a plant for separation of carbon dioxide (CO₂) from more volatile components in a gas mixture. The method can, for instance, be applied in connection with a hydrogen production plant and separate CO₂ from other gas components in a tail gas from a hydrogen purification unit operating on syngas generated in a hydrogen production plant based on natural gas reforming and shift reaction.

### BACKGROUND

Carbon capture, such as carbon capture and storage (CCS) and carbon capture utilization (CCU), is an important field of technology for reducing the release of carbon dioxide (CO₂) to the atmosphere. Carbon capture may involve separation of CO₂ from a gas mixture followed by purification and liquefaction of the separated CO₂.

EP2959243B1 shows an example where CO₂ is separated at sub-ambient (cryogenic) temperature from a gas mixture in the form of a residual gas from a hydrogen (H₂) production adsorption process or from an oxy-fuel combustion process.

The method of EP2959243B1 involves e.g. initial compressing and cooling the incoming gas flow, further cooling and partly condensing the gas flow (at −36° C.) in first heat exchanger 13, separating the partly condensed flow in first phase separator 15 producing an overhead gas 19 and a bottoms liquid 17, cooling and partly condensing the gas 19 in a second heat exchanger 23 (to −52.5° C.) where the partially condensed flow 25 is sent to a second phase separator 27. The gas 29 formed in the second phase separator 27 is heated in first exchanger 13 and heater 31, expanded in turbine 35, reintroduced in first exchanger 13 for cooling purposes and then heated and used for purification purposes. To avoid formation of solid particles, the liquid 43 (said to contain 97% CO₂) obtained from the second phase separator 27 is mixed with (expanded) liquid 45 obtained from the first phase separator 15. The mix of liquids 43 and 45 is expanded in second valve 47 to form expanded third flow sent to stripping column 51 from which overhead gas 81 is heated in first exchanger 13 and sent to initial compressor 3 and from which bottoms liquid 53 is split into a first portion 55 sent to second exchanger 23 (after partial vaporization in expansion valve 57) and a second portion sent to first exchanger 13. Vaporized portion 59 leaving second exchanger 23 is heated in first exchanger 13, compressed in product compressor 67 and cooled in coolers 69, 73 up to condensation. Liquid portion 61 leaving second exchanger 23 is pressurized in pump 75 and mixed with flow 59 after condensation to form carbon dioxide rich liquid product 76, pressurized in pump 77 to form pressurized product 79. The second portion of bottoms liquid 53 leaving stripping column 51 is vaporized in first exchanger 13 and thereafter split and either recirculated back to stripping column 51 or, fraction 65, sent to product compressor 67.

In a variant of EP2959243B1, there is no stripping column 51. Instead, to avoid formation of solid CO₂, the mix of liquids 43 and 45 form flow 46 that is split into a first portion sent via valve 57 to second exchanger 23 (as in the above variant) and a second portion sent via valve 56 to third phase separator 60. Gas 62 and liquid 64 from the third phase separator 60 are heated/vaporized in first exchanger 13, combined in flow 65 and pressurized in product compressor 67.

Although the principle of the method disclosed in EP2959243B1 is useful, there is a need for improving the efficiency of this principle, such as the purity of the CO₂ product, the CO₂ yield (sometimes denoted CO₂ capture rate, CCR), and the energy efficiency.

### SUMMARY

In one aspect, the disclosure concerns a process for separation of carbon dioxide (CO₂) from more volatile components in a gas mixture, the process comprising:
providing a bulk flow of the gas mixture;
compressing the bulk flow in a compressor arrangement to a pressure in the range 40-120 bara, wherein the compressor arrangement comprises a plurality of compressors or compressor stages arranged in series;
cooling the compressed bulk flow in a heat exchanger arrangement to a temperature in the range −45° C. to −60° C.;
separating the cooled and compressed bulk flow in a bulk vapour-liquid separator configured to separate cold bulk gas, depleted in CO₂, and cold bulk liquid, enriched in CO₂;
heating the cold bulk liquid in the heat exchanger arrangement so as to form a heated bulk liquid;
expanding and separating the heated bulk liquid in a flash separation arrangement comprising one or more flash separation units,
wherein each flash separation unit comprises a pressure reduction device and a corresponding vapour-liquid separation vessel,
wherein each flash separation unit is configured to separate an incoming liquid flow into an outgoing gas flow, depleted in CO₂, and an outgoing liquid flow, enriched in CO₂, and
wherein, when the flash separation arrangement comprises at least a first and a second flash separation unit arranged in series, the outgoing liquid flow from the first flash separation unit forms the incoming liquid flow for the second flash separation unit;
recirculating the one or more outgoing gas flows from the one or more flash separation units to the compressor arrangement, wherein each recirculated outgoing gas flow is fed to a compressor or compressor stage that i) operates at a pressure matching that of the outgoing gas flow fed thereto and that ii) is arranged downstream at least one other compressor or compressor stage in the compressor arrangement;
providing a CO₂ product flow from the outgoing liquid flow from the flash separation arrangement, and
providing a CO₂-depleted outgoing flow from the flow of cold bulk gas.

A process according to above differs from that of EP2959243B1 at least in that the one or more outgoing gas flows from the flash separation arrangement is/are recirculated and routed to an intermediate compressor (or compressor stage if using a multi-stage compressor) that operates at a pressure matching that of the outgoing gas flow fed thereto.

That the operating pressure of the compressor matches that of the gas flow means that the gas flow from each flash separation unit is routed to a compressor (stage) with operating pressures up to but not exceeding that of the corresponding vapour-liquid separation (flash) vessel. Typically, it also means that the gas flow is routed to the last compressor (stage), in the flow order of the bulk flow, that operates at a pressure that is below or up to the pressure of the corresponding gas flow/flash vessel. Accordingly, the one or more flashed gas flows need not be recompressed from the same low(est) compressor pressure level but from one (if only one recirculated gas flow) or more specific, matched and higher pressure levels. This lowers the total shaft power consumption for the process.

For instance, if the compressor arrangement comprises five compressors/stages in series and the flash separation arrangement comprises three flash separation units in series, a high-pressure gas flow from the first (in flow order) flash separation unit may be routed to the fifth (in flow order) compressor/stage, an intermediate-pressure gas flow from the second flash separation unit may be routed to the fourth compressor/stage, and a low-pressure gas flow (where “low” is in relation to the upstream flash separation units) from the third flash separation unit may be routed to the third compressor/stage.

All in all, the above-mentioned differences provide for a more efficient CO₂ separation process, for instance because of an improved energy efficiency as a result of the routing of the recirculated gas flows described above, but also because the flash separation arrangement improves the purity of CO₂ in the product flow, in particular when including a plurality of flash separation units. Further, the process of this disclosure may utilize a single compression operation to compress the entire feed stream/bulk flow and is arranged in such a way as to deliver both the CO₂ product and the residual tail gas stream, i.e. the cold bulk gas, at suitable pressure for onward processing without the need for re-compression. Moreover, recycling of vaporized gas from the flash separation arrangement improves the CCR.

The pressure value for the final flash stage should ideally be as close as possible to the triple point as possible, while providing sufficient margin to ensure reliable operation with respect to the risk of dry ice formation. The reason for this is that it maximises CO₂ purity as well as maximising heat recovery for scenarios in which medium/high pressure liquid product or dense phase product is desired. The triple pressure for pure CO₂ is 5.1 bara, so a suitable pressure would be in the range of 0.1-2 or 3 bar above this value, i.e. in the range 5.2 to 8 bara. How close to go is a function of e.g. confidence in process modelling, purity of the CO₂ and also the degree of non-ideality in the system.

The operating pressure for other flash vessel (upstream the final flash vessel/stage) will be determined by suitable pressure ratios relative to the final flash vessel and the ultimate discharge pressure of the compressor. In an example with three flash vessels, if 6 bara is selected for the final flash vessel, it may be suitable to set 15 bara for the 2nd flash vessel and 30 bara for the 1st flash vessel, based on a typical value of 2-2.5:1 pressure ratio in integrally geared compressors.

The gas mixture bulk flow may be a tail gas from a hydrogen purification unit operating on syngas from a hydrogen production plant based on natural gas reforming and shift reaction, such as a tail gas stream from a pressure swing adsorption unit in such a plant.

As an alternative to tail gas from hydrogen production, the gas mixture bulk flow may be any CO₂-containing gas as long as the CO₂ concentration is above around 40% and the accumulated composition of elements with boiling points above the boiling point of CO₂ (excluding water) is lower than the content that can be tolerated in the CO₂ product, for instance lower than 1%.

For hydrogen production plants, a single, five-stage integrally geared gas compressor (multi-shaft compressor) can possibly be used from very small plants all the way up to hydrogen production rates of up to 600,000 Nm3/h and 3 MPTA of CO₂ with a single train configuration, and higher can be achieved with multiple parallel trains. The compression may be from 0.3 bara to 40-120 bara, which may require at least five stages for an integrally geared compressor. A barrel type centrifugal compressor with multiple impellers in a single stage might reduce the stages to 3-4, but the integrally geared compressor is particularly well suited.

The compressor arrangement typically comprises a plurality of intercoolers arranged to cool the flow between the compressor stages.

The process of this disclosure allows for providing the CO₂-enriched outgoing product flow in different thermodynamic states. For instance, with only minor modifications the process can be configured for e.g. low (6-8 bara), medium (13-19 bara) or high pressure (40-50 bara) liquid product or dense phase (>80 bara). Producing liquid CO₂ may be essential for transportation in certain applications when pipelines cannot be used. To obtain different forms of the CO₂ product it is possible to vary the extent of heat integration between the product CO₂ and the heat exchangers. The gas compressor configuration can be unchanged and the product purity is not affected.

The accumulated concentration of components with boiling points higher than the boiling point of CO₂ in the bulk flow gas mixture is preferably less than 1 mole % (excluding water).

The CO₂ product flow typically contains at least 96% CO₂.

In the step of cooling the compressed bulk flow, the bulk gas is cooled to within a few degrees of the CO₂ freezeout temperature, which typically is in the range of −45° C. to −60° C., or −50° C. to −60° C., or −55° C. to −60° C., depending on the feed gas mixture composition.

The heat exchanger arrangement typically contains a plurality of heat exchangers and a plurality of types of heat exchangers. Exchangers used for heat transfer between process streams may be of a multi-stream type where heat is transferred between several streams/flows in a single unit operation. Heat exchange between process flows is important for heat integration. Exchangers using an external coolant for cooling of process streams are in this disclosure referred to as cooling units. As described further below, two multi-stream exchangers and two cooling units are preferably used in the process of this disclosure. It is possible to make use of heat exchanger units that involves heat exchange both between process-streams and between a process stream and an external coolant.

The cooling units exemplified below may use cooling mediums such as ethane, CO₂, various fluorinated hydrocarbons (R-116, R-41, R23, R-1132a, etc.), propane or ammonia to provide sufficient cooling.

The high-pressure cold CO₂ bulk liquid is heated in the heat exchanger arrangement before expansion to avoid formation of dry ice. The temperature of the heated CO₂ bulk liquid can be selected within some limits and forms a degree of freedom. Adding more heat to the stream results in enhanced stripping of dissolved impurities from the bulk liquid and increased volumetric gas flows from the flash stages. This temperature can be optimized together with the separation pressures to obtain a very pure CO₂ product. It also allows a slightly lower pressure in a low-pressure flash stage without formation of dry ice.

In the event that an ultra-high purity CO₂ stream is desired (e,g. with total dissolved components content less than e.g. 100 ppm), this can be achieved through the addition of a liquid CO₂ product stripper. This stripping column could feature a reboiler, condenser and packed column. The off gas from the stripper column would be routed back to the feed gas compressor, in a similar fashion to the flash vessel, thereby avoiding any CO₂ losses that may result from the purification step. The total shaft power of the feed gas compressor is marginally increased as a result of this feature, but it does not otherwise impact significantly on overall recovery or external refrigeration duty.

The cold bulk gas from the bulk vapour-liquid separator can be subject to additional treatment in a membrane separation unit. The membrane separation unit could comprise of one or multiple membrane separation stages. In a multiple-stage arrangement, the stages could contain membranes with selectivity for the same component, for instance CO₂, or for different components, for instance H₂ in a first stage and CO₂ in a consecutive stage. Each membrane separation stage could be arranged in a single- or multiple-pass arrangement. More than one pass implies that a low-pressure permeate stream be recompressed and recirculated to a high-pressure stream for another pass through a membrane.

If the membrane separation is targeted at additional CO₂-recovery from the cold bulk gas, the CO₂-enriched permeate stream would be recirculated to a stage of the integrally geared compressor at a lower pressure than the permeate stream. This additionally recovered CO₂ would complete another pass through the carbon capture plant. The net effect would be enhanced CO₂ recovery by the carbon capture plant.

In an embodiment, the flash separation arrangement comprises a plurality of, preferably at least three, flash separation units. As an example, the pressure of a final (e.g. third) stage of flash separation can be selected at a pressure of 6 bara, so selected as to be as close as possible to the triple point of CO₂ and also to match the interstage pressure of the tail gas compression such that the flashed vapour can be vented to the compression train. The selection of a compressor type which allows the flash to tie-in to the interstage pipe work, such as an integrally geared compressor, is important to enable this optimisation of matching interstage pressure with the required final flash stage pressure.

Relative volatility of components is pressure dependent, so selection of the three (or more) pressures used for the flashes (flash units) used to purify the product CO₂ is of importance. Use of three (or more) single equilibrium flashes which vent to the different interstage compression pressures allows for freer choice in flash pressure and a large step change in pressures, and therefore a larger flash than would occur in a conventional distillation column, where differential pressure is defined by the head of the liquid on each stage and would therefore not allow such a large pressure drop, or would require an infinite number of stages. The flashes are efficient and reliable.

The CO₂ purification section of the process thus comprises a flash unit, or multiple consecutive flash units for the separated high-pressure bulk liquid CO₂ at stepwise lower pressures. This introduces additional degrees of freedom since the pressure at each stage can be varied, which provides a potential for process optimization. The pressure at each flash stage is preferably rigorously optimized. The result can then be an essentially pure CO₂ product (>99.8% CO₂) in either liquid or dense phase wherein dissolved impurities, i.e., non-condensable and volatile components, are present only at low levels.

In an embodiment, the method further comprises heating the cold bulk gas in the heat exchanger arrangement by cooling the compressed bulk flow. The cold bulk gas is thus used as a cooling medium for cooling the incoming bulk flow.

In an embodiment, the heat exchanger arrangement comprises a first process-stream heat exchanger and a second process-stream heat exchanger, wherein the first process-stream heat exchanger is arranged upstream of the second process-stream heat exchanger with reference to a flow order of the compressed bulk flow.

In an embodiment, the cold bulk gas is heated, and the compressed bulk flow thereby cooled, in both the first and second process-stream heat exchangers, wherein the second process-stream heat exchanger is arranged upstream of the first process-stream heat exchanger with reference to a flow order for the cold bulk gas.

In an embodiment, the heat exchanger arrangement comprises a low-temperature cooling unit arranged downstream the second process-stream heat exchanger and upstream the bulk vapour-liquid separator with reference to the flow order of the compressed bulk flow. The low-temperature cooling unit makes of an external refrigerant to provide refrigeration to e.g. −55° C. or below. Ethane, CO₂ and various fluorinated hydrocarbons may be used, and the selection is governed by efficiency, cost, safety and environmental evaluations.

In an embodiment, the heat exchanger arrangement comprises a medium-temperature cooling unit arranged downstream the first process-stream heat exchanger and upstream the second process-stream heat exchanger with reference to the flow order of the compressed bulk flow.

In some applications it is beneficial to use a higher temperature external refrigerant, such as propane or ammonia, in the medium-temperature cooling unit to increase/maximise heat transfer to the cold bulk liquid in the second process-stream heat exchanger, and reduce/minimise the duty of the low-temperature cooling unit. Increased heating of cold bulk liquid leads to increased flashing in the flash separation arrangement, which increases the CO₂ product purity by boiling off a greater extent of dissolved gasses (CO, H₂ etc.).

In an embodiment, the compressor arrangement comprises at least three, preferably five, compressors or compressor stages arranged in series.

In an embodiment, the method further comprises: heating the resulting outgoing liquid flow from the flash separation arrangement in the heat exchanger arrangement so as to form the main outgoing product flow.

The outgoing product may be a liquid with a range of saturation temperatures ranging from −55° C. to +33° C., or be a dense phase fluid with a temperature greater than the critical temperature and pressure greater than the critical pressure of pure CO₂.

In an embodiment, the resulting outgoing liquid flow from the flash separation arrangement is heated in at least the second process-stream heat exchanger.

A low-pressure liquid CO₂ product may be obtained directly from the flash separation arrangement. The pressure of the liquid product can be increased by heating the product flow to a certain extent in one or both process-stream heat exchangers.

In an embodiment, a vapour-liquid pre-separator is arranged between the first and second process-stream heat exchangers, wherein the pre-separator is configured to partially separate the bulk flow coming from the first process-stream heat exchanger into a CO₂-depleted flow that is fed to the second process-stream heat exchanger and a CO₂-enriched flow that is fed to the flow of heated bulk liquid.

In an embodiment, the vapour-liquid pre-separator is arranged between the medium-temperature cooling unit and the second process-stream heat exchanger.

In the process of this disclosure, the compressed gas may be progressively cooled from the discharge of the compressor to the bulk separator by means of exchangers (incl. coolers). Due to the relatively wide boiling range of this gas, CO₂ rich liquid may start to precipitate during this process. This may result in some issues:

Once there is two phase fluid formed, it becomes a challenge to ensure that downstream heat exchangers perform as designed. Achieving a good distribution of a two-phase fluid is challenging particularly if a particular exchanger must be designed to operate at a range of pressures, temperature, and vapor fractions.

A second issue is that exchanger duty and heat transfer area may unnecessarily be used for subcooling fluids that have already condensed, without any benefit to the separation process. This may increase size and cost of exchangers and external coolers.

A third issue is that the separation of the residue gas may be performed in a single stage in the bulk separator. The subsequent flash stage(s) for the liquid CO₂ stream help to remove dissolved gasses, but are constrained by the fact that this gas is recycled via the compressor, and the equilibrium is reestablished in the bulk separator. As a result, the CO₂ product produced by the process may not be as pure a desired.

By providing the pre-separator, all liquid that has condensed at this stage is removed. Effects of this arrangement are: i) only gas is sent to the second multi-stream heat exchanger, which addresses the challenges associated with two-phase fluid distribution in a heat exchanger; ii) it reduces the mass flow to downstream exchangers substantially, which in turn reduces the duty/cost of these exchangers; iii) at the higher temperature in the pre-separator, compared to the bulk separator, the solubility of dissolved gasses is lower, thus reducing the amounts of gasses like CO dissolved in the liquid CO₂. In addition, while the conditions and therefore saturation concentrations in the bulk separator are not changed, the substantially recued quantity of liquid CO₂ separated at this location with the pre-separator installed, means that the total mass flow of dissolved gasses present in the liquid stream from the bulk separator is also reduced.

In an embodiment, a further pre-separator is added downstream of the second process-stream exchanger but upstream of the low-temperature cooling unit. This provides an incremental benefit similar in nature to the first pre-separator discussed above, and can be used instead of or in addition to the first pre-separator.

In an embodiment, the cold bulk gas is heated in both the first and the second process-stream heat exchanger, wherein the second process-stream heat exchanger is arranged upstream of the first process-stream heat exchanger with reference to a flow order of the cold bulk gas.

In an embodiment, the method further comprises: recirculating the cold bulk gas through the second process-stream heat exchanger via an expander.

In an embodiment, the expander is connected to a re-compressor via a shaft so as to drive the re-compressor, wherein the re-compressor is arranged to re-compress the cold bulk gas when the flow of cold bulk gas has passed the first process-stream heat exchanger.

The purpose of passing the CO₂ depleted cold bulk gas through the expander is both to reduce the pressure to the respective operating pressure of any connected process but also to gain cooling through non-adiabatic expansion. The shaft power from an expander of the type discussed may typically be used in the following applications: 1) Conversion to heat via an oil cooled break; 2) Reduction of compression shaft power via coupling to the tail gas compressor, sometimes known as a compander; and 3) Generation of electricity via a generator. Each of these solutions is typically sub-optimal for the following reasons: 1) If the expander shaft power is converted to heat the energy is lost. This is a relatively low-cost solution, but it is also the least efficient. 2) Connecting the expander to the tail gas compressor is a poor solution because expanders operate most efficiently when they are designed as variable speed devices, however the tail gas compressor is typically a fixed speed machine. The technical challenges of this arrangement can be overcome, but it increases process complexity, and will make start-up more difficult. 3) In generation of electricity via a generator, again because the load and speed of the expander is ideally variable, the result power from the generator will also be variable in both load and frequency. It is possible to convert a variable frequency power source into a fixed frequency power source, but it is complex and expensive, and given the low amount of power compared with the tail gas compressor, unlikely to be a cost-effective solution.

An advantageous alternative is to use a turbo-expander as defined above. In this solution, an expander and a compressor are directly coupled and will operate at the same speed. Ideally the streams that each side of the device process will be related to each other, such that as the flow to the expander varies, the flow to the re-compressor also changes, thus ensuring consistent ratio of shaft power to load.

The expander and the re-compressor are processing the same fluid but at different points in the process, in this case the expander location remains unchanged, while the re-compressor is located downstream of the first process-stream heat exchanger. Because the re-compressor provides for some degree of pressure recovery, it also allows the expander to operate with greater pressure drop. This in turn increases both the cooling across the expander and therefore a greater degree of heat transfer in the second multi-stream heat exchanger, which in turn reduces duty in a downstream low-temperature cooler. Because the process stream being expanded is the same stream that is recompressed, this ensures that the unit will have no difficulty in dealing with operational variations in flow and load. The estimated performance improvement from using this Turbo-expander configuration is a 12% reduction in duty on the low temperature cooler.

In an embodiment, the method further comprises: dehydrating the bulk flow in a dehydration unit before cooling the compressed bulk flow. This is thus an arrangement for removing water from the bulk flow. Dehydration units in processes of the type of concern in this disclosure are well known as such.

In an embodiment, the dehydration unit is arranged downstream the compressor arrangement. This means there is no compression of the bulk flow downstream of the dehydration unit.

In an embodiment, the bulk flow of the gas mixture is a tail gas from a hydrogen purification unit operating on syngas from a hydrogen production process.

In an embodiment, the CO₂-depleted outgoing flow is routed back to the hydrogen production process. This flow may e.g. be recirculated into a water-gas-shift section, reformer and/or gasifier of a hydrogen production process.

In another aspect, the disclosure concerns a plant for separation of carbon dioxide (CO₂) from more volatile components in a gas mixture, the plant comprising:
a compressor arrangement configured to compress a bulk flow of the gas mixture to a pressure in the range 40-120 bara, wherein the compressor arrangement comprises a plurality of compressors or compressor stages arranged in series;
a heat exchanger arrangement configured to cool the compressed bulk flow to a temperature in the range −45° C. to −60° C.;
a bulk vapour-liquid separator configured to separate the cooled and compressed bulk flow and form cold bulk gas, depleted in CO₂, and cold bulk liquid, enriched in CO₂;
   wherein the heat exchanger arrangement is configured to heat the cold bulk liquid so as to form a heated bulk liquid;
a flash separation arrangement configured to expand and separate the heated bulk liquid, wherein the flash separation arrangement comprises one or more flash separation units,
wherein each flash separation unit comprises a pressure reduction device and a corresponding vapour-liquid separation vessel,
wherein each flash separation unit is configured to separate an incoming liquid flow into an outgoing gas flow, depleted in CO₂, and an outgoing liquid flow, enriched in CO₂, and
wherein, when the flash separation arrangement comprises at least a first and a second flash separation unit arranged in series, the outgoing liquid flow from the first flash separation unit forms the incoming liquid flow for the second flash separation unit;
one or more fluid lines configured to recirculate the one or more outgoing gas flows from the one or more flash separation units to the compressor arrangement, wherein the fluid lines are arranged so that each outgoing gas flow can be fed to a compressor or compressor stage that i) operates at a pressure matching that of the outgoing gas flow fed thereto, and that ii) is arranged downstream at least one other compressor or compressor stage in the compressor arrangement;
a CO₂ product flow outlet in fluid connection with a resulting outgoing liquid flow from the flash separation arrangement, and
a CO₂-depleted outgoing flow outlet from the flow of cold bulk gas.

### BRIEF DESCRIPTION OF DRAWINGS

In the description given below reference is made to the following figure, in which:

FIG. 1 shows a first embodiment of the process and plant of this disclosure.

FIG. 2 shows a second embodiment of the process and plant of this disclosure.

FIG. 3 shows a third embodiment of the process and plant of this disclosure.

FIG. 4 shows the embodiment of FIG. 3 but with an integrated compressor indicated.

FIG. 5 shows a fourth embodiment of the process and plant of this disclosure.

FIG. 6 shows a fifth embodiment of the process and plant of this disclosure.

FIG. 7 shows a sixth embodiment of the process and plant of this disclosure.

FIG. 8 shows a seventh embodiment of the process and plant of this disclosure.

### DETAILED DESCRIPTION

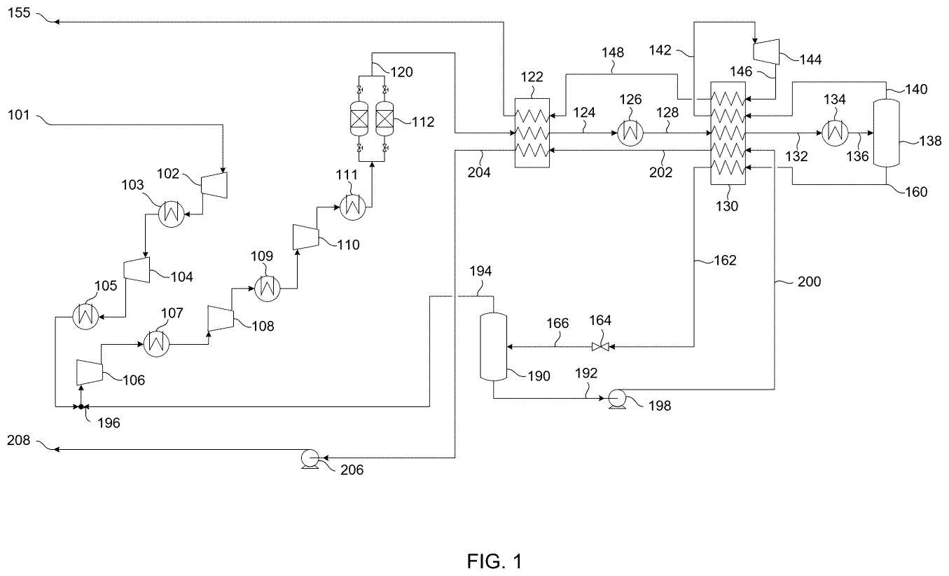

FIG. 1 shows, in a schematic view, a first embodiment of a process and plant for separation of carbon dioxide (CO₂) from more volatile components in a gas mixture. The process/plant of FIG. 1 may be described as follows:

An incoming bulk flow 101 of the gas mixture may be a tail gas from a pressure swing adsorption unit of a hydrogen production process based on natural gas reforming and shift reaction.

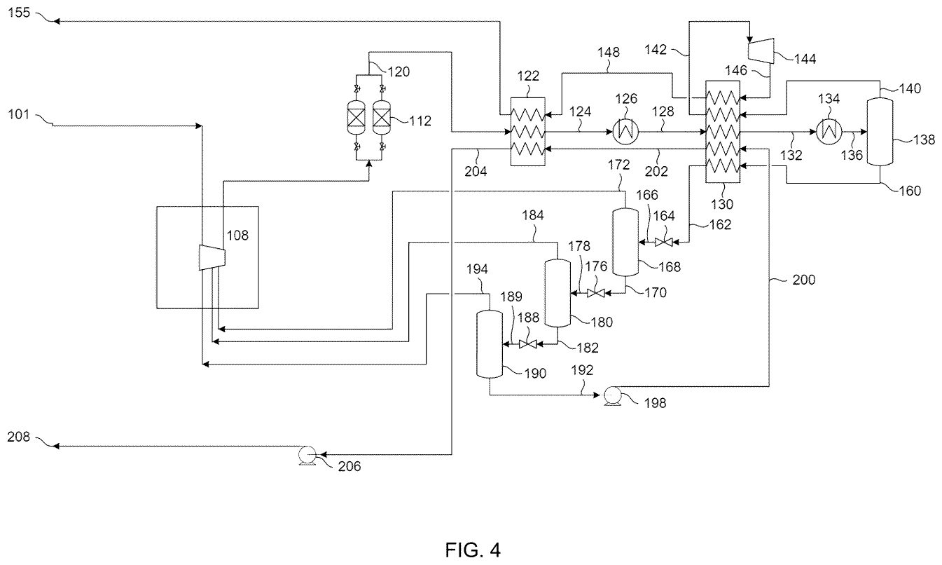

The bulk flow 101 is compressed to typically around 60 bara in a compressor arrangement comprising five compressors or compressor stages 102, 104, 106, 108, 110 and five corresponding coolers 103, 105, 107, 109, 111, all arranged in series. The compressors may form separate units, as indicated in FIG. 1, but the compressor arrangement may instead (or as a complement) comprise an integrally geared multi-stage compressor, as indicated in FIG. 4.

A dehydration unit 112 for removing water from the bulk flow is arranged downstream the compressor arrangement 102-111.

The compressed bulk flow 120 is cooled in a heat exchanger arrangement that in this example comprises a first multi-stream heat exchanger 122, a medium-temperature (MT) cooling unit/refrigerator 126, a second multi-stream heat exchanger 130, and a low-temperature (LT) cooling unit/refrigerator 134 so as to form a flow 136 having a temperature of typically −55° C. to −60° C.

The multi-stream heat exchangers 122, 130 are used for transferring heat between different flows in the process, whereas the cooling units 126, 134 make use of external refrigerants, such as propane or ammonia for the MT cooling unit 126 and ethane for the LT cooling unit 134.

The cooled and compressed bulk flow 136 is fed to a bulk vapour-liquid separator 138 configured to separate cold bulk gas 140, depleted in CO₂, and cold bulk liquid 160, enriched in CO₂. The cold bulk liquid 160 is heated in the second multi-stream heat exchanger 130 (while cooling the bulk flow 128 coming in from the MT cooling unit 126) so as to form a heated bulk liquid 162.

The heated bulk liquid 162 is expanded and separated in a flash separation arrangement that in this example comprises one single flash separation unit that in turn comprises a pressure reduction device, indicated as valve 164, and a corresponding vapour-liquid separation vessel 190. Other arrangements of the flash separation unit are possible. The flash separation unit is configured to separate the incoming liquid flow 162 into an outgoing gas flow 194, depleted in CO₂, and an outgoing liquid flow 192, enriched in CO₂.

The outgoing flow 192 is in this example fed via pump 198 to the second multi-stream heat exchanger 130 and further (flow 202) to the first multi-stream heat exchanger 122 so as to, via pump 206, form an outgoing CO₂ product flow 208. This treatment of the flow 192 forms a dense phase liquid CO₂ product flow.

The outgoing gas flow 194 from the flash separation unit is recirculated to the compressor arrangement 102-111. More in particular, the outgoing gas flow 194 is fed to a specific compressor stage, in this case to point 196 at the third stage 106, that operates at a pressure that matches that of the outgoing gas flow 194. That is, this specific compressor stage 106 operates at a pressure that is below or up to, but does not exceed, the pressure of the separation vessel 190. Further, this specific compressor stage 106 is the last compressor stage, in the flow order of flow 101, that operates at a pressure that is below or up to the pressure of the separation vessel 190.

The cold bulk gas 140 is heated in both the first and second multi-stream heat exchangers 122, 130 (where “first” is the second in flow order for flow 140) and thereby cools the bulk flow 120 flowing into the first exchanger 122 as well as the bulk flow 128 coming in from the MT cooling unit 126 and flowing into the second exchanger 130. The flow 140 eventually forms an outgoing flow 155, that may be recirculated into a hydrogen production process from which the bulk flow 101 may originate.

The cold bulk gas 140 is recirculated through the second multi-stream heat exchanger 130 via an expander 144 (flows 142 and 146). Flow 148 is the expanded flow towards the first exchanger 122.

The outgoing flow 155 from the first exchanger 122 may be routed back to the hydrogen production process from which the feed flow 101 is obtained.

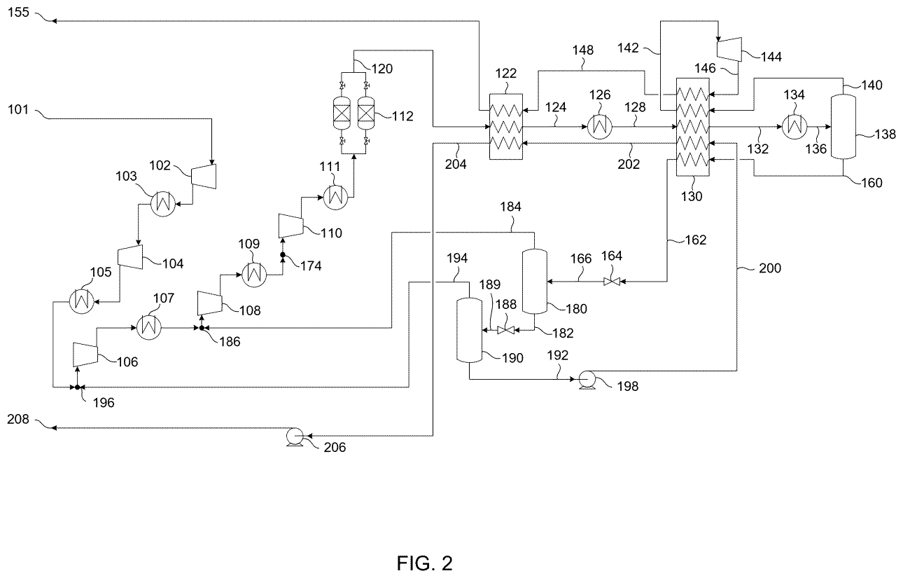

FIG. 2 shows, in a schematic view, a second embodiment of a process and plant for separation of carbon dioxide (CO₂) from more volatile components in a gas mixture.

A difference between the embodiments of FIGS. 1 and 2 is that the flash separation arrangement of the embodiment of FIG. 2 comprises two flash separation units, an intermediate-pressure (IP) flash separation unit is arranged upstream a low-pressure (LP) flash separation unit.

The LP flash separation unit corresponds to the flash separation unit shown in FIG. 1 and comprises pressure reduction device 188 and corresponding vapour-liquid separation vessel 190. The IP flash separation unit comprises pressure reduction device 164 and corresponding vapour-liquid separation vessel 180.

Each flash separation unit is configured to separate the incoming liquid flow 162, 182 into an outgoing gas flow 184, 194, depleted in CO₂, and an outgoing liquid flow 182, 192, enriched in CO₂. The outgoing liquid flow 182 from the IP flash separation unit forms the incoming liquid flow 182 for the LP flash separation unit.

The outgoing gas flow 184 from the IP flash separation unit has a higher pressure than the gas flow 194 of the LP unit and is fed to point 186 and into the fourth compressor stage 108 in the compressor arrangement where the pressure is higher than at point 196 and matches the outgoing gas flow 184 from the IP flash separation unit.

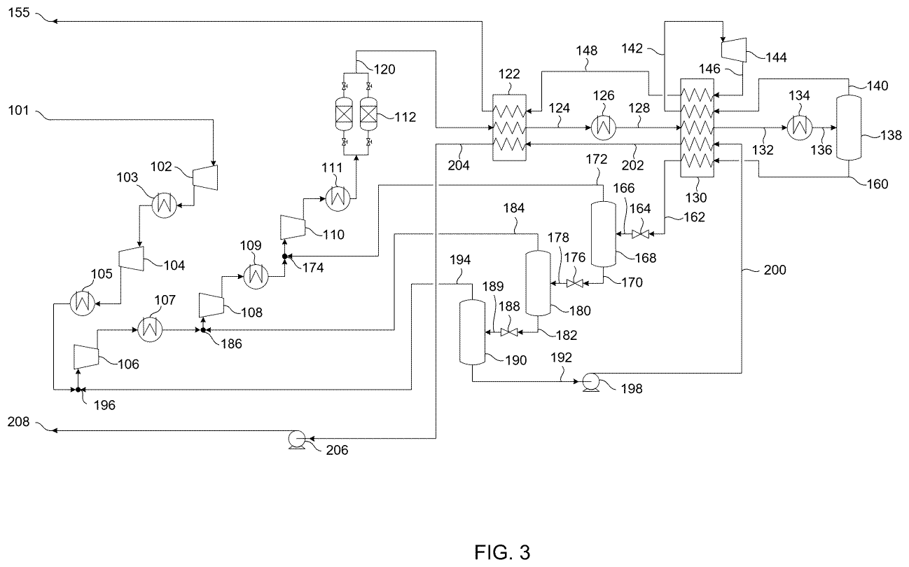

FIG. 3 shows, in a schematic view, a third embodiment of a process and plant for separation of carbon dioxide (CO₂) from more volatile components in a gas mixture.

A difference between the embodiments of FIGS. 2 and 3 is that the flash separation arrangement of the embodiment of FIG. 3 comprises three flash separation units; besides the intermediate-pressure (IP) and low-pressure (LP) flash separation units shown in FIG. 2, a high-pressure (HP) flash separation arranged upstream the IP flash separation unit.

The LP and IP flash separation units correspond to the units shown in FIG. 2 and comprises pressure reduction devices 188 and 176 and corresponding vapour-liquid separation vessels 190 and 180, respectively. The HP flash separation unit comprises pressure reduction device 164 and corresponding vapour-liquid separation vessel 168.

As in FIG. 2, each flash separation unit is configured to separate the incoming liquid flow 162, 170, 182 into an outgoing gas flow 172, 184, 194, depleted in CO₂, and an outgoing liquid flow 170, 182, 192, enriched in CO₂. The outgoing liquid flow 170 from the HP flash separation unit forms the incoming liquid flow 170 for the IP flash separation unit.

The outgoing gas flow 172 from the HP flash separation unit has a higher pressure than the gas flow 184 of the IP unit and is fed to point 174 and into the fifth and last compressor stage 110 in the compressor arrangement where the pressure is higher than at point 186 and thus matches the pressure of the outgoing gas flow 172 from the HP flash separation unit.

FIG. 4 shows the embodiment of FIG. 3 but indicates the use of an integrally geared multi-stage compressor (which is given the general reference number 108 in FIG. 3).

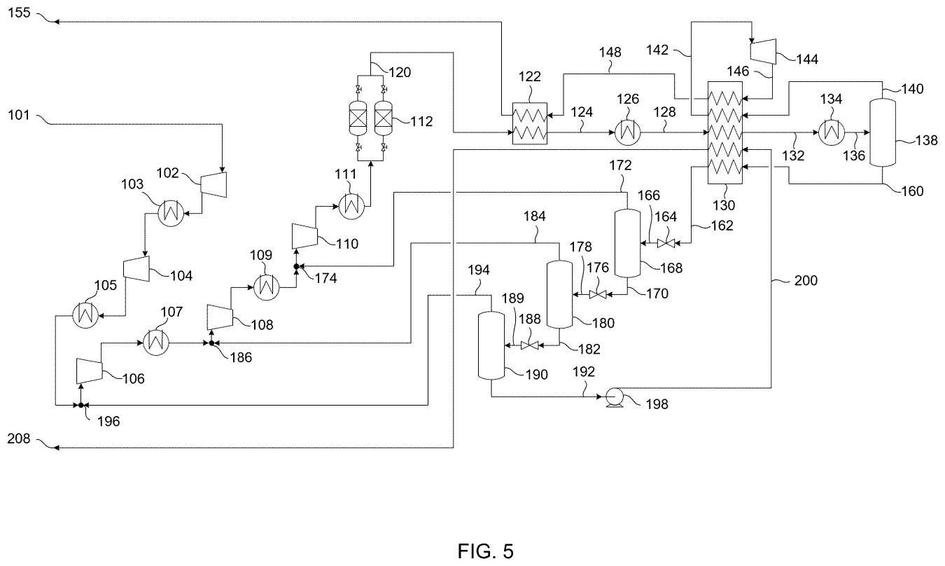

FIG. 5 shows, in a schematic view, a fourth embodiment of the process and plant of this disclosure. The embodiment of FIG. 5 is similar to that of FIGS. 3 and 4, but in FIG. 5 the outgoing liquid flow 192 from the flash separation arrangement is heated only in the second process-stream heat exchanger 130. This forms an MP liquid CO₂ product. The first process-stream heat exchanger 122 forms in FIG. 5 a two-stream heat exchanger.

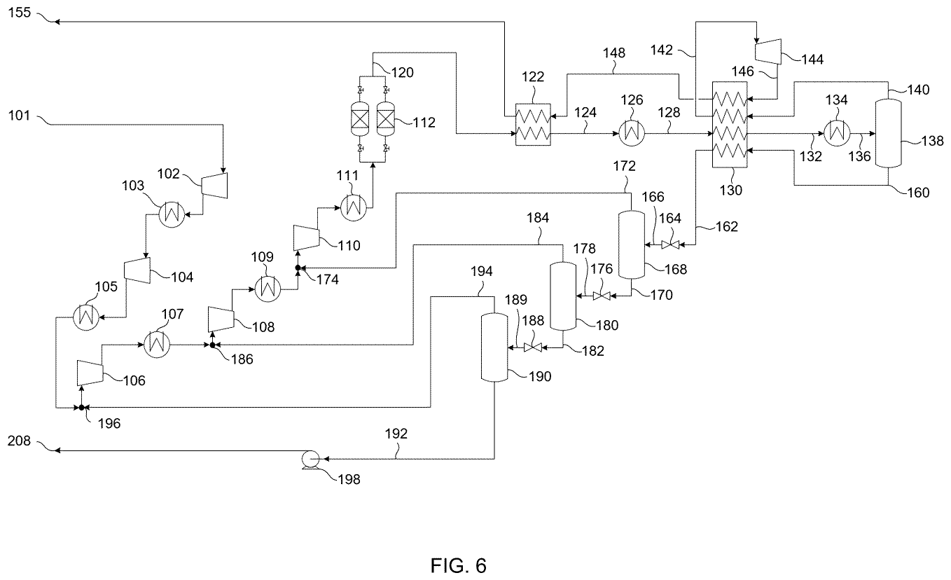

FIG. 6 shows, in a schematic view, a fifth embodiment of the process and plant of this disclosure. This example is similar to that of FIG. 5 but in FIG. 6 there is no heating of the outgoing liquid flow 192 from the flash separation arrangement.

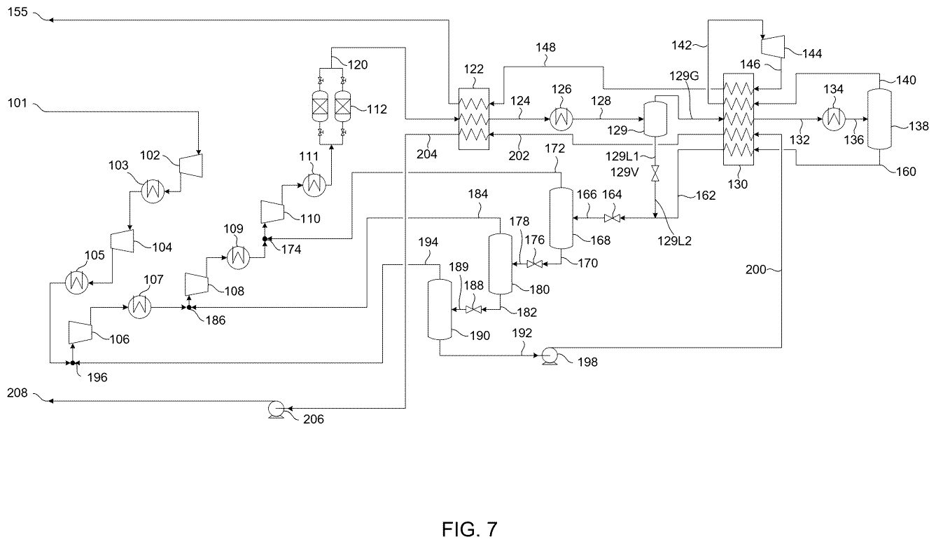

FIG. 7 shows, in a schematic view, a sixth embodiment of the process and plant of this disclosure. The embodiment of FIG. 7 is similar to that of FIGS. 3 and 4 but in this example there is a vapour-liquid pre-separator 129 arranged between the medium-temperature cooling unit 126 and the second process-stream heat exchanger 130. The pre-separator 129 is configured to partially separate the bulk flow 124, 128 coming from the first process-stream heat exchanger 122 into a CO₂-depleted flow 129G fed to the second process-stream heat exchanger 130 and a CO₂-enriched flow 129L1/129L2 that is fed via valve 129V to the flow of heated bulk liquid 162.

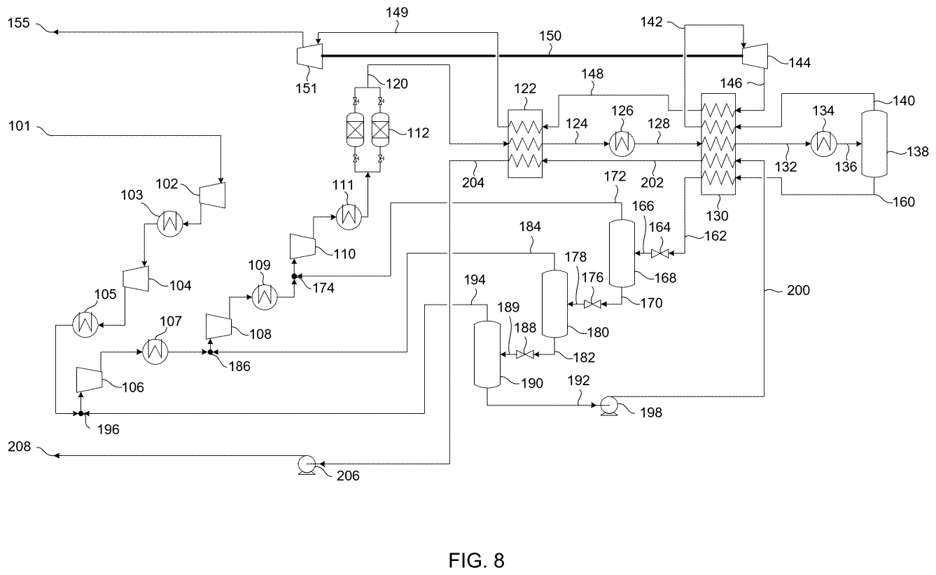

FIG. 8 shows, in a schematic view, a seventh embodiment of the process and plant of this disclosure. The embodiment of FIG. 8 is similar to that of FIGS. 3 and 4 but in this example the expander 144 is connected to a re-compressor 151 via a shaft 150 so as to drive the re-compressor 151, wherein the re-compressor 151 is arranged to re-compress the cold bulk gas 140 when the flow of cold bulk gas 140 has passed (indicated as flow 149) the first process-stream heat exchanger 122.

The disclosure is not limited by the embodiments described above but can be modified in various ways within the scope of the claims. For instance, the CO₂ product flow can be provided in different thermodynamic states when a pre-separator or re-compressor is used or when the number of flash separation units is other than exemplified. Further, some embodiments may include a combination of pre-separator(s) and re-compressor, and some embodiments may include more than three flash separation units.

### REFERENCE NUMBERS

101 PSA tail-gas
102 First compression stage
103 First intercooler
104 Second compression stage
105 Second intercooler
106 Third compression stage
107 Third intercooler
108 Fourth compression stage
109 Fourth intercooler
110 Fifth compression stage
111 Compression aftercooler
112 Dehydration unit
120 Dehydrated tail-gas
122 First multi-stream heat exchanger
124 First cooled bulk feed
126 Medium-temperature (MT) refrigeration
128 Second cooled bulk feed
129 Pre-separator
129L1 Pre-separated liquid
129L2 Pre-separated stream downstream throttle valve
129G Pre-separated vapor
129V Throttle valve for pre-separated liquid
130 Second multi-stream heat exchanger
132 Third cooled bulk feed
134 Low-temperature (LT) refrigeration
136 Bulk separator feed
138 Bulk separator
140 Cold bulk gas
142 First heated bulk gas
144 Cryo-expander
146 Expanded bulk gas
148 Second heated bulk gas
149 Third heated bulk gas
150 Turbo-expander shaft
151 Re-compressor
155 Cleaned tail-gas
164 High-pressure (HP) flash valve
166 High-pressure (HP) flash vessel feed
168 High-pressure (HP) flash vessel
170 Separated high-pressure (HP) liquid
172 Separated high-pressure (HP) gas
174 Third recycle
176 Intermediate-pressure (IP) flash valve
178 Intermediate-pressure (IP) flash vessel feed
180 Intermediate-pressure (IP) flash vessel
182 Separated intermediate-pressure (IP) liquid
184 Separated intermediate-pressure (IP) gas
186 Second recycle
188 Low-pressure (LP) flash valve
189 Low-pressure (LP) flash vessel feed
190 Low-pressure (LP) flash vessel
192 Separated low-pressure (LP) liquid
194 Separated low-pressure (LP) gas
196 First recycle
198 Liquid CO₂ pump
200 Cold purified CO₂
202 First heated purified CO₂
204 Second heated purified CO₂
206 Dense phase CO₂ pump
208 CO₂ product

1. A process for separation of carbon dioxide (CO₂) from more volatile components in a gas mixture, the process comprising:
providing a bulk flow of the gas mixture;
compressing the bulk flow in a compressor arrangement to a pressure in the range 40-120 bara, wherein the compressor arrangement comprises a plurality of compressors or compressor stages arranged in series;
cooling the compressed bulk flow in a heat exchanger arrangement to a temperature in the range −45° C. to −60° C.;
separating the cooled and compressed bulk flow in a bulk vapour-liquid separator configured to separate cold bulk gas, depleted in CO₂, and cold bulk liquid (160), enriched in CO₂;
heating the cold bulk liquid in the heat exchanger arrangement so as to form a heated bulk liquid;
expanding and separating the heated bulk liquid in a flash separation arrangement comprising one or more flash separation units,
wherein each flash separation unit comprises a pressure reduction device and a corresponding vapour-liquid separation vessel,
wherein each flash separation unit is configured to separate an incoming liquid flow into an outgoing gas flow, depleted in CO₂, and an outgoing liquid flow, enriched in CO₂, and
wherein, when the flash separation arrangement comprises at least a first and a second flash separation unit arranged in series, the outgoing liquid flow from the first flash separation unit forms the incoming liquid flow for the second flash separation unit;
recirculating the one or more outgoing gas flows from the one or more flash separation units to the compressor arrangement, wherein each recirculated outgoing gas flow is fed to a compressor or compressor stage that i) operates at a pressure matching that of the outgoing gas flow fed thereto and that ii) is arranged downstream at least one other compressor or compressor stage in the compressor arrangement;
providing a CO₂ product flow from the outgoing liquid flow from the flash separation arrangement, and
providing a CO₂-depleted outgoing flow from the flow of cold bulk gas.

2. The process according to claim 1, wherein the flash separation arrangement comprises a plurality of, preferably three, flash separation units.

3. The process according to claim 1, wherein the method further comprises:
heating the cold bulk gas in the heat exchanger arrangement by cooling the compressed bulk flow.

4. The process according to claim 1, wherein the heat exchanger arrangement comprises a first process-stream heat exchanger and a second process-stream heat exchanger, wherein the first process-stream heat exchanger is arranged upstream of the second process-stream heat exchanger with reference to a flow order of the compressed bulk flow.

5. The process according to claims 3, wherein the cold bulk gas is heated, and the compressed bulk flow thereby cooled, in both the first and second process-stream heat exchangers, wherein the second process-stream heat exchanger is arranged upstream of the first process-stream heat exchanger with reference to a flow order for the cold bulk gas.

6. The process according to claim 4, wherein the heat exchanger arrangement comprises a low-temperature cooling unit arranged downstream the second process-stream heat exchanger and upstream the bulk vapour-liquid separator with reference to the flow order of the compressed bulk flow.

7. The process according to claim 4, wherein the heat exchanger arrangement comprises a medium-temperature cooling unit arranged downstream the first process-stream heat exchanger and upstream the second process-stream heat exchanger with reference to the flow order of the compressed bulk flow.

8. The process according to claim 1, wherein the compressor arrangement comprises at least three, preferably five, compressors or compressor stages arranged in series.

9. The process according to claim 1, wherein the method further comprises:
heating the outgoing liquid flow from the flash separation arrangement in the heat exchanger arrangement so as to form the CO₂ product flow.

10. The process according to claims 4, wherein the outgoing liquid flow from the flash separation arrangement is heated in at least the second process-stream heat exchanger.

11. The process according to claim 4, wherein a vapour-liquid pre-separator is arranged between the first and second process-stream heat exchangers, wherein the pre-separator is configured to partially separate the bulk flow coming from the first process-stream heat exchanger into a CO₂-depleted flow that is fed to the second process-stream heat exchanger and a CO₂-enriched flow that is fed to the flow of heated bulk liquid.

12. The process according to claim 7, wherein the vapour-liquid pre-separator is arranged between the medium-temperature cooling unit and the second process-stream heat exchanger.

13. The process according to claim 4, wherein the method further comprises:
recirculating the cold bulk gas through the second process-stream heat exchanger via an expander.

14. The process according to claims 5, wherein the expander is connected to a re-compressor via a shaft so as to drive the re-compressor, wherein the re-compressor is arranged to re-compress the cold bulk gas when the flow of cold bulk gas has passed (flow 149) the first process-stream heat exchanger.

15. The process according to claim 1, wherein the method further comprises:
dehydrating the bulk flow in a dehydration unit before cooling the compressed bulk flow.

16. The process according to claim 15, wherein the dehydration unit is arranged downstream the compressor arrangement.

17. The process of claim 1, wherein the bulk flow of the gas mixture is a tail gas from a pressure swing adsorbed syngas from a hydrogen production process.

18. The process of claim 17, wherein all or some of the CO₂-depleted outgoing flow is routed back to the hydrogen production process.

19. A plant for separation of carbon dioxide (CO₂) from more volatile components in a gas mixture, the plant comprising:
a compressor arrangement configured to compress a bulk flow of the gas mixture to a pressure in the range 40-120 bara, wherein the compressor arrangement comprises a plurality of compressors or compressor stages arranged in series;
a heat exchanger arrangement configured to cool the compressed bulk flow to a temperature in the range −45° C. to −60° C.;
a bulk vapour-liquid separator configured to separate the cooled and compressed bulk flow and form cold bulk gas, depleted in CO₂, and cold bulk liquid, enriched in CO₂;
wherein the heat exchanger arrangement is configured to heat the cold bulk liquid so as to form a heated bulk liquid;
a flash separation arrangement configured to expand and separate the heated bulk liquid, wherein the flash separation arrangement comprises one or more flash separation units,
wherein each flash separation unit comprises a pressure reduction device and a corresponding vapour-liquid separation vessel,
wherein each flash separation unit is configured to separate an incoming liquid flow into an outgoing gas flow depleted in CO₂, and an outgoing liquid flow, enriched in CO₂, and
wherein, when the flash separation arrangement comprises at least a first and a second flash separation unit arranged in series, the outgoing liquid flow from the first flash separation unit forms the incoming liquid flow for the second flash separation unit;
one or more fluid lines configured to recirculate the one or more outgoing gas flows from the one or more flash separation units to the compressor arrangement, wherein the fluid lines are arranged so that each outgoing gas flow can be fed to a compressor or compressor stage that i) operates at a pressure matching that of the outgoing gas flow fed thereto, and that ii) is arranged downstream at least one other compressor or compressor stage in the compressor arrangement;
a CO₂ product flow outlet in fluid connection with a resulting outgoing liquid flow from the flash separation arrangement, and
a CO₂-depleted outgoing flow outlet from the flow of cold bulk gas.
